(19) United States
(12) Patent Application Publication
(10) Pub. No.: US 2026/0108826 A1
(43) Pub. Date: Apr. 23, 2026

(54) RARE EARTH ELEMENT EXTRACTION AND RECYCLING

(71) Applicant: Voyager Technologies, Inc., Denver, CO (US)

(72) Inventors: Mark Berggren, Golden, CO (US); Franklin D. R. Maharaj, Boulder, CO (US); Katherine Knudtsen, Denver, CO (US); Katie Thorne, Denver, CO (US); Joseph Schmidt, Golden, CO (US); Stacy Carrera, Golden, CO (US); Boris Nizamov, Highlands Ranch, CO (US)

(21) Appl. No.: 19/288,783

(22) Filed: Aug. 1, 2025

Related U.S. Application Data
(60) Provisional application No. 63/678,911, filed on Aug. 2, 2024.

(51) Int. Cl. B01D 11/02; C01F 17/247; C22B 3/02; C22B 3/04; C22B 3/22; C22B 3/44; C22B 59/00

(52) U.S. Cl. CPC B01D 11/0288; B01D 11/0207; B01D 11/0292; C01F 17/247; C22B 3/02; C22B 3/04; C22B 3/22; C22B 3/44; C22B 59/00

(57) ABSTRACT

Systems and methods herein provide for Rare Earth Element Extraction and Recycling (REEER). One system extracts and recovers rare earth elements (REEs) from magnet-containing feedstock using a leaching reactor, an oxidizing gas, and a carbonate-based leaching solution. The leaching reactor selectively dissolves non-rare-earth constituents and produce a leachate comprising dissolved species and solid rare earth residues. The system also comprises a solid-liquid separation subsystem to separate solid residues from the leachate, and a precipitation subsystem to precipitate rare earth carbonate solids. The system also comprises a filtration and washing subsystem to recover and purify the rare earth carbonate solids, a regeneration subsystem to react the solution with carbon dioxide to reform the carbonate leaching agent for reuse. A process control system manages the flows among the leaching reactor, precipitation subsystem, regeneration subsystem, such that the system operates in a closed-loop manner with minimal reagent loss and high-purity REE product recovery.

### CROSS REFERENCE TO RELATED APPLICATIONS

This patent application claims priority to, and thus the benefit of an earlier filing date from, U.S. Provisional Patent Application No. 63/678,911 (filed Aug. 2, 2024), the contents of which are hereby incorporated by reference.

### BACKGROUND

Rare earth elements (REEs) are critical components in a wide range of high-tech and strategic products, including permanent magnets, smartphones, hearing aids, wind turbines, industrial motors and generators, and catalytic converters. Among these, neodymium-based permanent magnets are particularly valued for their exceptional magnetic strength, making them important for many advanced technological and energy applications.

Despite their widespread use, the United States has limited domestic production capacity for rare earth materials, including neodymium. As a result, it remains heavily dependent on foreign sources for supply. This reliance introduces significant vulnerabilities into the supply chain, particularly in light of rising geopolitical tensions that may disrupt or restrict international trade flows of these materials. Consequently, ensuring a stable and secure domestic supply of REEs has become a matter of national economic and strategic interest.

An additional challenge in rare earth production is the natural co-occurrence of REEs in ores. In the context of neodymium magnet production, mining operations frequently yield an excess of other rare earth elements, such as lanthanum and cerium. This leads to an undesirable supply imbalance, wherein production of the target REE (e.g., neodymium) necessitates surplus output of less demanded elements. Such inefficiencies underscore the need for alternative approaches to REE acquisition that do not perpetuate this imbalance.

Currently, the recycling and recovery rates for REE-based magnets, whether used in consumer products, industrial equipment, or military systems, remain exceedingly low. Post-consumer and manufacturing waste streams containing these magnets are typically mixed with other materials, making separation and recovery both difficult and costly. Various recovery methods have been explored, such as hydrogen decrepitation and molten magnesium extraction. However, these techniques suffer from significant drawbacks. For example, some require the use of toxic or corrosive gases, produce lower-purity REE outputs, and/or entail prohibitive economic costs.

Accordingly, there exists a pressing need for an environmentally sustainable, cost-effective, and scalable process for the recovery and recycling of neodymium and other REEs from both manufacturing scrap and end-of-life products. A solution to this problem would mitigate the environmental impact of fresh ore extraction, reduce dependence on foreign supply chains, and help rebalance domestic REE production, all while preserving the performance quality of recovered materials suitable for reuse in critical applications.

### SUMMARY

Systems and methods herein provide for Rare Earth Element Extraction and Recycling (REEER). The present embodiments provide for the recovery of rare earth elements (REEs) from magnet-containing feedstocks through a closed-loop leaching, precipitation, and regeneration process. The system utilizes a carbonate-based leachant and oxidative digestion to extract base metals while preserving rare earths as precipitable carbonates. CO₂ sparging is employed to recover REEs from solution, and the spent leach solution is regenerated for reuse, reducing waste and reagent demand. The integrated architecture supports scalable deployment from laboratory to commercial-scale operations.

In one embodiment, a system for extracting and recovering rare earth elements (REEs) from magnet-containing feedstock comprises a leaching reactor configured to receive magnet feedstock, an oxidizing gas, and a carbonate-based leaching solution, the leaching reactor being operable to selectively dissolve non-rare-earth constituents and produce a leachate comprising dissolved species and solid rare earth residues. The system also comprises a solid-liquid separation subsystem coupled to the leaching reactor and configured to separate solid residues from the leachate, producing a clarified leachate stream, and a precipitation subsystem fluidly coupled to the solid-liquid separation subsystem, the precipitation subsystem comprising a sparging device and configured to receive carbon dioxide gas and the clarified leachate stream, and operable to precipitate rare earth carbonate solids. The system also comprises a filtration and washing subsystem fluidly coupled to the precipitation subsystem, configured to recover and purify the rare earth carbonate solids, a regeneration subsystem configured to receive spent leaching solution and to react the solution with carbon dioxide to reform the carbonate leaching agent for reuse, and one or more recycle loops fluidly coupling the regeneration subsystem to the leaching reactor for delivering regenerated leach solution back to the leaching reactor. The system also comprises a process control system configured to manage the flow of solids, liquids, and gases among the leaching reactor, precipitation subsystem, regeneration subsystem, and recycle loops, such that the system operates in a closed-loop manner with minimal reagent loss and high-purity REE product recovery.

The various embodiments disclosed herein may be implemented in a variety of ways as a matter of design choice. For example, some embodiments herein are implemented in hardware, whereas other embodiments may include processes that are operable to implement and/or operate the hardware. Other exemplary embodiments, including hardware, software, firmware, and various combinations thereof are described below.

### BRIEF DESCRIPTION OF THE FIGURES

Some embodiments are now described, by way of example only, and with reference to the accompanying drawings. The same reference number represents the same element or the same type of element on all drawings.

FIG. 1 is a block diagram of a model of a Rare Earth Element Extraction and Recycling (REEER) process, in one exemplary embodiment.

FIG. 2 is a REEER process flow diagram, in one exemplary embodiment.

FIG. 3 is a REEER solution regeneration module process flow diagram, in one exemplary embodiment.

FIG. 4 is a REEER recycle bleed and byproduct recovery module process flow diagram, in one exemplary embodiment.

FIG. 5 is a REEER reactor, in one exemplary embodiment.

FIG. 6 is a Pourbaix diagram of iron in aqueous solution, in one exemplary embodiment.

FIG. 7 is a high-flow experiment on the one-kilograms scale system where 500 grams of feed was loaded, in one exemplary embodiment.

FIGS. 8A and 8B illustrate iron to rare-earth ratio in the cake after repeated leaching cycles, and selectivity and yield for the REEER process using an incremental loading feed system, in one exemplary embodiment.

FIG. 9 illustrates a relative composition of rare earth elements after separations treatments, in one exemplary embodiment.

FIG. 10 is an initial laboratory batch solution regeneration test configuration, in one exemplary embodiment.

FIG. 11 illustrates a CO2 flow rate from initial solution regeneration experiment, in one exemplary embodiment.

FIG. 12 illustrates a CO2 release profile from improved batch solution regeneration configuration, in one exemplary embodiment.

FIG. 13 is a laboratory flow representing in-situ solution regeneration, in one exemplary embodiment.

FIG. 14 illustrates CO2 release during laboratory conditions representing in-situ solution regeneration, in one exemplary embodiment.

FIG. 15 illustrates a gas composition during in-situ regeneration experiment, in one exemplary embodiment.

FIG. 16 is a block diagram of an exemplary computing system in which a computer read-able medium provides instructions for performing one or more methods herein.

### DETAILED DESCRIPTION OF THE FIGURES

The figures and the following description illustrate various exemplary embodiments. It will thus be appreciated that those skilled in the art will be able to devise various arrangements that, although not explicitly described or shown herein, embody various principles of design and/or operation and are included within the scope of the embodiments. Furthermore, any examples described herein are intended to aid in understanding the principles of the embodiments and are to be construed as being without limitation to such specifically recited examples and conditions.

### Industrial Process Modelling

Rare Earth Element Extraction and Recycling (REEER) material and energy balances form the foundation of the economic analysis of a commercial plant. The basic process flow was established through experimentation and modeling of unit operations. The process was then carried out to detail the material balance and to establish energy inputs for the closed-loop magnet recycling process.

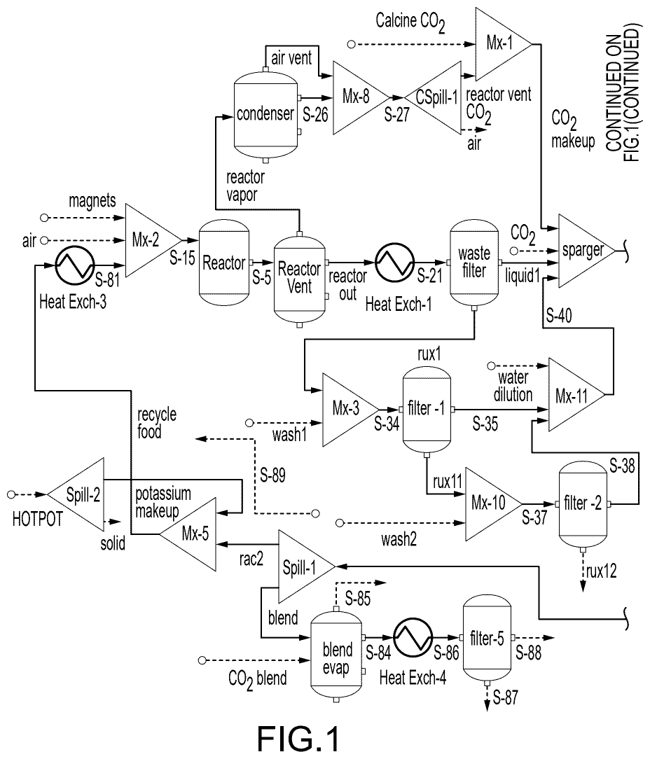

FIG. 1 illustrates a complete process-level system diagram for rare earth element (REE) extraction and recycling to convert post-consumer magnet materials into reusable rare earth oxides, in one exemplary embodiment. The flow diagram begins with a feed preparation step, where magnet scrap is introduced alongside potassium carbonate leach solution and air into a preheater labeled Heat Exch-3. This heated mixture is directed via stream S-1 into a blower (Min-2), which propels the mixture into the main leaching reactor.

A material hopper receives post-consumer and industrial magnet waste and delivers it via vibratory feeder to a primary shredder, where the magnets are size-reduced. This shredder connects to a screw conveyor that transports fragmented material to a reactive soaking tank equipped with an agitator. Here, the feedstock is pre-treated with a mild aqueous carbonate solution to remove surface oils and oxidation products.

Downstream, the slurry flows through a centrifugal pump into a filtration module, where coarse solids are removed. The filtrate enters a first leaching reactor, supplied with potassium carbonate (K2CO3) and sparged with air introduced through a blower, to promote iron oxidation and solubilization.

Gas inlet lines deliver regulated air or oxygen, monitored by a mass flow controller, while thermocouples track reactor temperature, maintained by immersion heaters. pH probes monitor leaching conditions in real-time.

From the leaching reactor, the slurry enters a solid-liquid separator where the first cake (iron-rich) is filtered out. The filtrate advances to a second leaching reactor where REE-containing solids are further dissolved. This step is also monitored by pH and temperature control systems.

Next, the solution is transferred to a precipitation tank, where a carbonate stream induces rare earth carbonate precipitation. A vacuum filter press collects the solid REE carbonate (cake 2). A washing station rinses the precipitate to remove residual reagents.

The filtrate is routed to a regeneration loop including a CO₂ gas cylinder, bubble column reactor, and regeneration tank where potassium carbonate is replenished by bubbling CO₂ into spent solution. A circulation pump and vent scrubber complete the loop.

Solids from cake 2 are sent to a spray dryer and then to a rotary calciner, forming purified REE oxides. These are collected in a sealed product bin and weighed.

Process flows are tracked by flow meters, check valves, and diverter lines, ensuring containment and efficiency. Waste is collected in a liquid waste tank and solid residue drum for safe disposal.

In the lower-left quadrant, potassium carbonate is introduced into the system from a make-up source and blended with a recycled feed stream. This mixture flows through Mix-5 and Split-2 to merge with bleed gas (from Split-3 and Split-4), entering a CO₂ scrubber and solution reactor. The resulting carbonate-rich leach solution is directed via Heat Exch-4 into a central Reactor, where magnet scrap and air are simultaneously introduced. Air is pulled through Heat Exch-3 (“Heat Exch” being a heat exchanger) and mixed with magnetic solids in Mix-2 before entering the reactor via line S-1.

Inside the Reactor, oxidative digestion occurs to selectively extract base metals. Gaseous products exit through the Reactor Vent, pass through a condenser, and are ultimately vented. The leach liquor containing dissolved values is cooled by Heat Exch-1 and proceeds to a multi-stage solid-liquid separation train. Solids are filtered in Filter1, washed, and separated for disposal or iron recovery. In some embodiments, The oxidative digestion reactor may be operated at temperatures between 70° C. and 110° C. and under a slightly positive pressure (0.2-1.5 atm above ambient).

The filtrate is split, part being directed to Filter2, Filter3, and Filter4 for REE carbonate precipitation following CO₂ sparging, while another portion is routed through Sep-3 and Heat Exch-2 for further purification. Precipitated solids are washed (via Wash1 to Wash4), and vacuum-assisted filtration stages (Mech-10 through Mech-14) recover the purified REE cake. In some embodiments, CO₂ sparging for rare earth carbonate precipitation is performed at ambient to slightly elevated pressure (1-2 atm) and between 30° C. to 60° C., optimized for maximum precipitation yield and selectivity.

Meanwhile, the spent liquor is cycled through a regeneration loop. From Filter1, the solution is routed to a carbonation tower and a scrubber to react with CO₂ bleed. The regenerated carbonate solution is collected, reheated if necessary, and pumped back to the leach reactor. Throughout the system, numerous pumps, heat exchangers, and phase separators (Sep-2, Sep-4, Sep-5) manage material flow and thermal balance.

Make-up and recycled CO₂ streams converge and are routed to the sparging section through Mix-3 and Split-5. Sparging induces REE precipitation. Condensers (Cond-2) and pressure-maintaining equipment (Pump-1) ensure recovery and recycle of gas and liquid media. All couplings (e.g., fluidic, thermal, pneumatic) are configured to minimize reagent loss, maximize closed-loop reuse, and maintain energy efficiency in a high-throughput operational setting.

In some embodiments, the Reactor is a vertical, pressurized vessel where air-oxidative leaching takes place to selectively dissolve iron and other undesired metals, while rare earth elements (REEs) remain in solid form. Reactor off-gases exit through a dedicated Reactor Vent, proceeding through a condenser to recover moisture and finally vent to atmosphere. Liquid and solid output from the reactor proceed through Heat Exch-1 for temperature control, followed by solid-liquid separation via Filter1. The resulting iron-rich cake (Cake 1) is collected, and the filtrate, now containing dissolved REEs and carbonate salts, advances into the regeneration system.

Carbonate regeneration occurs in the lower left portion of the diagram, beginning with a CO₂ absorption subsystem fed by CO₂ bleed and sweep gases (Split-3, Split-4). These gases interact with the filtrate in a regeneration reactor, with the temperature maintained via Heat Exch-4. The regenerated potassium carbonate solution is recycled back into the main reactor through pump and valve networks, supporting a closed-loop leaching operation.

Parallel to this, the rare earth-rich stream is directed into a secondary precipitation and filtration line. After cooling (Heat Exch-2) and further conditioning, the solution enters a rare earth precipitation reactor where controlled sparging of CO₂ induces selective carbonate precipitation. The resulting REE-rich solids are processed through successive washing and filtration units (Filter2, Filter3, Filter4), with intermediate separators and mechanical devices (e.g., Mech-12, Mech-13) removing entrained liquids and controlling cake moisture.

The purified REE cake (Cake 2) is collected for downstream thermal conversion (not shown in this diagram), while liquid waste and raffinate streams are directed through separators (Sep-3, Sep-4, Sep-5) and venting units for polishing and emission control. Condensate is recovered and recycled through Cond-2 and Pump-1.

A recycle network routes clean solution back into the process at several points via automated valves and splitters (e.g., Split-2, Split-5), ensuring minimal loss of reagents and maximizing process efficiency. The entire system is designed to facilitate closed-loop processing of REEs with efficient regeneration, selective separation, minimal waste, and compatibility with post-consumer magnet feedstocks.

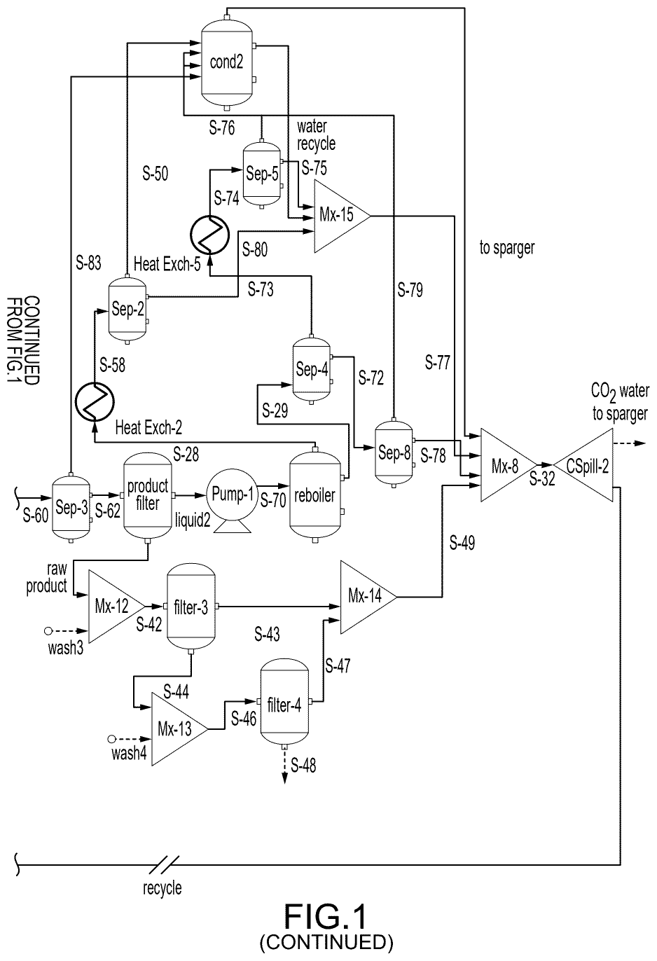

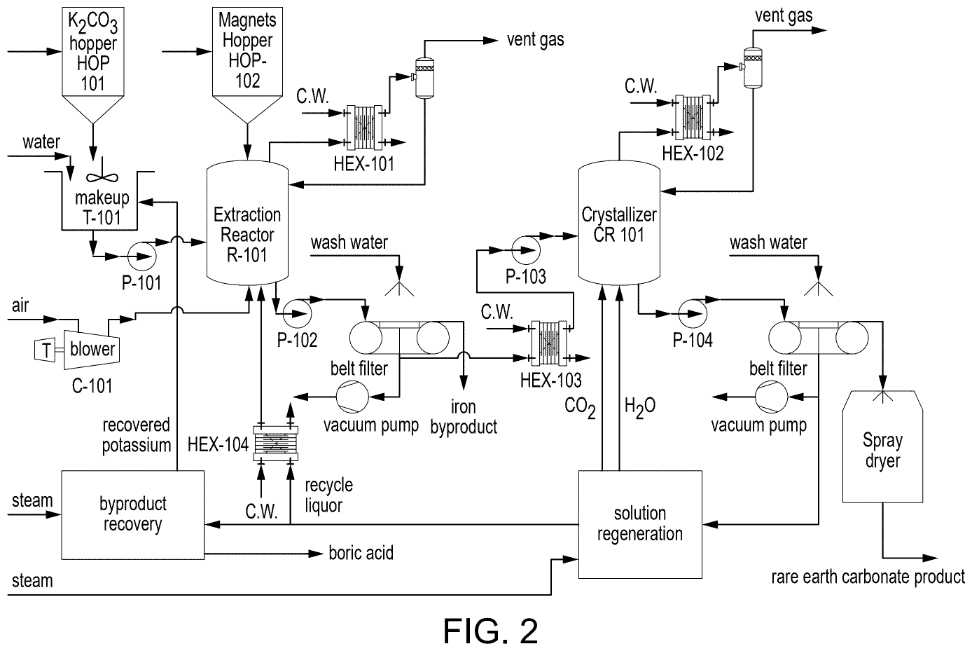

A baseline integrated process flow diagram (PFD) was established based on the OLI model outputs. The model is based on continuous processing and is being applied to the PFD for a nominal feed of six metric tons per day of magnet manufacturing waste for selective recovery of rare earths and co-generation of an iron-oxide-rich product. Preliminary PFDs of the proposed REEER plant are shown in FIGS. 2-4 note that equipment identification tags are preliminary and may change as the hardware is further defined during the course of the process and economic evaluations. The chemical process starts at the extraction reactor, where the magnet waste is dissolved. As shown in the PFD, the streams entering the extraction reactor are:
1. Recycle stream from the solution regeneration module (e.g., an evaporator) constitutes the bulk of the liquid flow.
2. Makeup stream, which is needed to add potassium lost in the bleed stream. This stream will be mixed with the recycle stream before the reactor so that a single reactor nozzle can be used.
3. Airstream to oxidize the magnet material
4. The waste magnet feed

The airflow was set to have oxygen flow twice the flow needed to oxidize the magnet material. This is generally in line with experimental work. The ratio of oxygen to magnetic material is important for the kinetics of the oxidation reaction and for achieving sufficient oxidizing potential to form iron oxides in a manner that facilitates filtration. The temperature in the reactor can be controlled using the temperature of the recycle stream, so using airflow to control the reactor temperature is not necessarily required. The airflow rate changes how much CO₂ and water vapor evolve along with the outflow air stream. Higher air excess will cause more CO₂ to be released (beyond the process needs to maintain a high pH during extraction). Due to this consideration, the air excess was limited to two times over the stoichiometric amount.

CO₂ contained in the reactor vent could be recovered using an amine sorption process. However, the cost of additional equipment may be high, considering that CO₂ concentration in the vent stream is low. One useful aspect is identifying the relative importance of the various CO₂ sinks: for example, vent CO₂ loss versus CO₂ loss in the uncalcined rare earth product. Generally, vent loss dominates. Although the preliminary baseline approach uses air, a potential trade for using pure oxygen (or oxygen-enriched air) against potential heat losses and CO₂ concentration in the vent gas was also identified.

The air in the reactor vent contains water vapor. This water vapor is recovered using the condenser heat exchanger and a vertical knockout drum. Water recovered here is approximately the same amount of water that will be lost in the cooling tower. However, this additional equipment limits the amount of minerals entering the process with the makeup water. This reduces the requirements placed on the quality of the makeup water.

After the extraction reactor, the iron oxide rich solid residue is filtered. The temperature of the extraction reactor outflow is lowered using a heat exchanger. This provides a broader choice of materials for the filter media. A vacuum filter belt is configured with the wash as a filtering unit operation. Other equipment can be used, such as a filter press. The selection of equipment needs to be made based on performance during additional demonstrations and pilot plant campaigns. From the process standpoint, two cake washes are used, and most of the neodymium is recovered from the iron oxide rich cake.

The filtered liquor is sent into the precipitation reactor to crystallize the product, neodymium, and other rare earth carbonates. The product is precipitated by lowering the pH of the solution. This is achieved by sparging CO₂ into the precipitation reactor solution. Sparging CO₂ converts some carbonate into bicarbonate, and due to the lower solubility of potassium bicarbonate relative to potassium carbonate, the solubility limit can be exceeded. Therefore, liquor entering the precipitation reactor is diluted with water to avoid that. Just enough water is added to prevent the precipitation of the potassium bicarbonate. This added water is then removed in the evaporator unit, along with the added CO₂ in FIG. 2. Note that a mixed rare earth oxide product can be produced by calcining the REEER carbonate product. However, the carbonate form may be more amenable as feed to rare earth separations before reduction to metal.

A thermodynamic model predicts neodymium hydroxide carbonate solubility lower than neodymium carbonate solubility in the precipitation reactor. Since the oversaturation for both species is high, it is likely that both these species will precipitate simultaneously. From the economic analysis viewpoint, it makes little difference which neodymium species (carbonate or hydroxycarbonate) precipitates. The amount of carbonate lost in the product is significantly less than the amount of CO₂ lost in the reactor vent. The cost of CO₂ makeup is not significantly affected by how well the thermodynamic model predicts the composition of the solids in the precipitation reactor.

The precipitated rare earth product is filtered, and the clear liquor is sent to the solution regeneration (evaporator) module. As mentioned, the water and CO₂ added to the precipitation reactor is removed before the solution can be recycled into the extraction reactor. This can be accomplished in many ways as a matter of design choice.

A distillation column can remove the required amounts of water and CO₂. For energy efficiency, two more flow processes of the evaporator were explored. Mechanical vapor recompression (MVR) can reduce steam requirements and/or a triple-effect evaporator may be used to reduce steam usage. The triple effect evaporator flow is shown in FIG. 2.

In some embodiments, components in contact with corrosive leachate may be constructed from materials such as titanium, fluoropolymer-lined steel, or high-nickel alloys to resist corrosion. And, gaskets, seals, and tubing may use PTFE or EPDM materials compatible with carbonate solutions and elevated temperatures.

Although potassium carbonate (K₂CO₃) is generally preferred, the leaching agent may alternatively comprise sodium carbonate (Na₂CO₃) or mixed alkali carbonates. Additionally, the regeneration subsystem may be configured with packed-bed CO₂ absorbers or membrane contactors depending on throughput scale. And, the REE precipitation subsystem may operate in batch or continuous modes with staged carbonation reactors for multi-zone selectivity.

In some embodiments, sensors for pH, redox potential, temperature, and conductivity are distributed throughout the system to ensure stable operation. Automated feedback control systems may be used to dynamically adjust air flow, CO₂ sparging rate, and recirculation ratios to optimize performance. And, the system may include programmable logic controllers (PLCs) for regulating process timing and batch-to-batch consistency.

In some embodiments, the permanent magnet feedstock may contain between 10-35 wt. % total REEs, with neodymium (Nd), prascodymium (Pr), and dysprosium (Dy) being predominant. And, the potassium carbonate leach solution may be used at concentrations ranging from 0.5 M to 2.5 M.

The carbonate system embodiments herein substantially eliminate hazardous byproducts and enable easier downstream separation, as opposed to acid-based leaching techniques. And, the closed-loop regeneration reduces reagent consumption by more than 80%, lowering operational costs. The modular architecture also supports both pilot and commercial-scale deployment using skid-mounted subsystems.

FIG. 2 depicts the airflow-supported extraction reactor subsystem, in one exemplary embodiment. A blower (C-101) pulls ambient air into an air preheater, warming the gas before it enters the extraction vessel (R-101). The reactor houses magnet feed immersed in a potassium carbonate solution. Air oxidizes Fe(II) to Fe(III), facilitating selective dissolution of iron without solubilizing REEs. The gas exits through a vent scrubber, and the liquid is routed to a settler or filtration unit.

The system includes four shell-and-tube or plate-type heat exchangers designated as HEX-101 through HEX-104, each serving a distinct thermal regulation role within the REE recovery process. HEX-101 is fluidly coupled to the outlet of the extraction reactor (R-101) and is used to cool the product liquor and vapor stream prior to gas separation, minimizing vapor-phase carryover and enabling controlled venting. HEX-102, positioned downstream of the crystallizer (CR-101), performs a similar function by condensing water and CO₂ vapors evolved during rare earth carbonate precipitation, protecting the downstream gas handling unit. HEX-103 cools the crystallized slurry before solid-liquid separation, thereby enhancing filter cake formation and maintaining REE carbonate stability. Lastly, HEX-104 is situated along the recycle liquor line and reheats or tempers the potassium carbonate solution before it reenters the extraction reactor. This configuration ensures tight thermal control across the integrated leaching, crystallization, and regeneration operations.

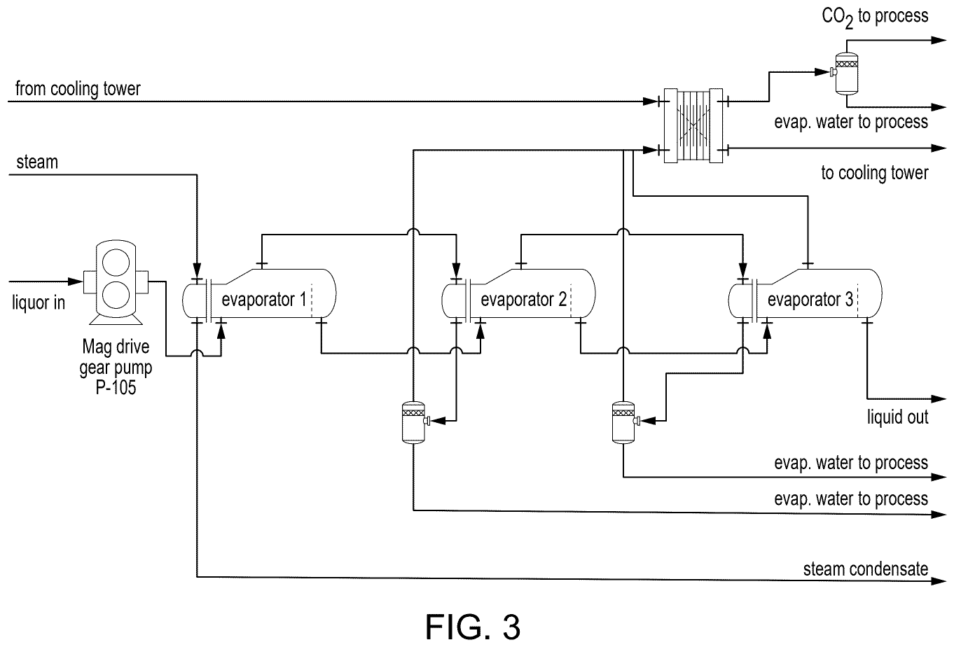

FIG. 3 illustrates a three-stage evaporator train for concentrating process liquor through successive water removal operations, in one exemplary embodiment. Liquor enters the system via a magnetic drive gear pump (P-105), which delivers it under pressure into Evaporator 1, the first of three heat-driven evaporation chambers. Steam is applied to the shell side of each evaporator to provide the thermal energy needed for evaporation. The partially concentrated liquor exits Evaporator 1 and flows sequentially into Evaporator 2 and then Evaporator 3, where further water removal occurs, resulting in a progressively higher concentration of dissolved solids. Each evaporator has a vapor outlet connected to a demister, which removes entrained liquid droplets from the vapor stream before routing it to a shared condenser. The demisters ensure clean, dry vapor reaches the condenser and minimize process fluid loss.

The condensed vapor (i.e., primarily water) is split between two destinations: process reuse and cooling water return. A line labeled “CO₂ to process” is also connected downstream of the condenser to capture any entrained CO₂ for reuse in upstream carbonation or regeneration steps.

The condensed steam from the heating side of the evaporators is collected and routed through a steam condensate drain line. Final concentrated liquor exits the system at the rightmost outlet, labeled “liquor out,” and is directed to subsequent stages of rare earth recovery or crystallization. The design of the three-evaporator train maximizes energy efficiency and concentration throughput while providing flexibility for water and CO₂ recovery.

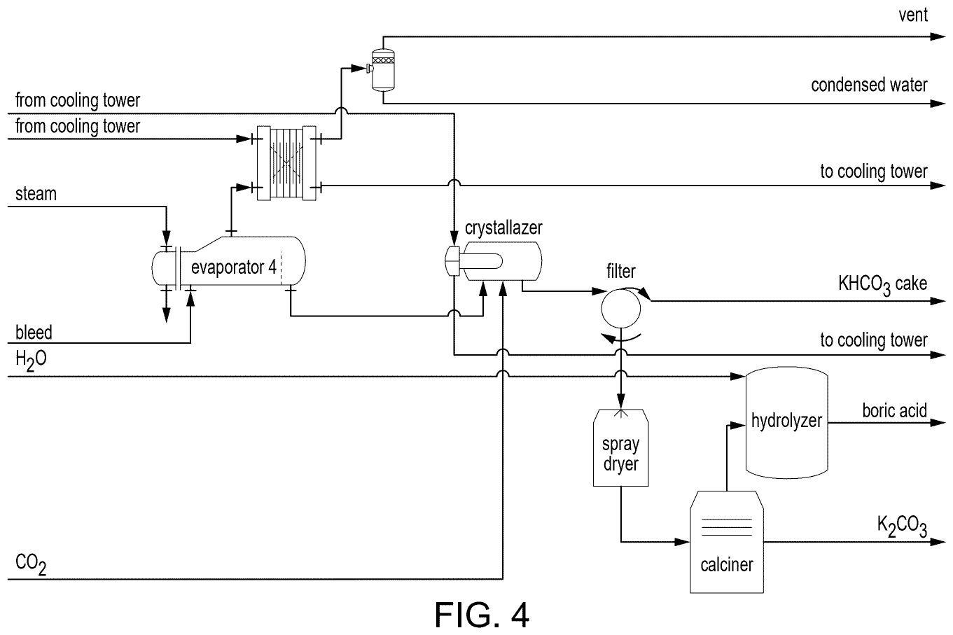

FIG. 4 illustrates the post-precipitation thermal treatment and product recovery subsystem used to convert separated rare earth carbonate solids into purified rare earth oxide (REO) powder suitable for reuse in high-performance applications, in one exemplary embodiment. The subsystem includes a fluid path that passes through an evaporator, spray dryer, and calciner, with auxiliary systems including gas handling, filtration, and solids transfer lines. This arrangement thermally decomposes REE carbonate solids, removes water and carbonates, and produces fine REO powder.

The slurry containing rare earth carbonate solids enters a feed tank equipped with a mechanical agitator to maintain suspension. This tank is fluidly coupled to a transfer pump, which moves the slurry to an Evaporator 4. The evaporator uses indirect steam heating to drive off excess water from the slurry. The resulting thickened slurry then passes to a spray dryer, which atomizes the material into fine droplets within a hot gas stream, rapidly evaporating remaining moisture and converting the slurry into fine dry powder.

The dried solids exit the spray dryer and are conveyed to a calciner, a rotary or fluidized bed thermal treatment unit, where carbonate components are decomposed, and REE oxides are formed. The calciner is fluidly and thermally coupled to a gas handling system that includes filters for particulate control and a vent line for evolved gases. Fine REO particles are collected at the output of the calciner via a cyclone separator or baghouse filter, then discharged to a final product hopper.

Supporting connections include a steam inlet to the evaporator, a hot air blower supplying the spray dryer, and insulated transfer conduits between each major unit. Recovered vapors are passed through condensers and demisters for emission control and water recovery. The entire system may be enclosed to minimize dust release and designed for continuous operation in downstream REE oxide production.

This reduces steam usage by 40% by using a liquid pump to compress the liquid to 10 bar before the first evaporator. The pressures in the evaporators are 10 bar, 4 bar, and 1 bar. The liquid pump's Coefficient of Performance (C.O.P.) is approximately 300, showing that the trade of the pump's electrical power and steam duty is justified.

Experimentally, boron contained in magnet alloy may be extracted into the liquid phase but is not amenable to precipitation under the conditions employed for rare earth compound recovery. Therefore, a bleed stream may be needed to limit the buildup of boron species in the recycled extraction solution. Without a bleed, boron species will start to precipitate as potassium metaborate salts. However, potassium (e.g., in the form of dissolved carbonate and bicarbonate compounds) will be lost through the bleed stream if potassium recovery is not implemented. First, the bleed liquor is concentrated by evaporating water. Then the concentrated liquor was cooled, and CO₂ was sparged through it. This recovers potassium from the bleed stream by forcing potassium bicarbonate to precipitate. Approximately 70% of the total potassium in the bleed stream can be recovered this way.

The remaining 30% of potassium can be recovered in some other way. For example, boron species can be precipitated and calcined to produce diboron trioxide. The diboron trioxide can be hydrolyzed to orthoboric acid, a product stream, instead of a waste stream. Complete processing of the bleed stream is possible. Additional technology development to selectively remove or partially remove boron from the recycled solution is recommended because this would significantly reduce the bleed stream rate while boosting the recycle of potassium compounds.

In summary, a framework for determining potassium, carbon dioxide, and water makeups was established for multiple scenarios. Steam usage and cooling tower duties are also calculated for select conditions.

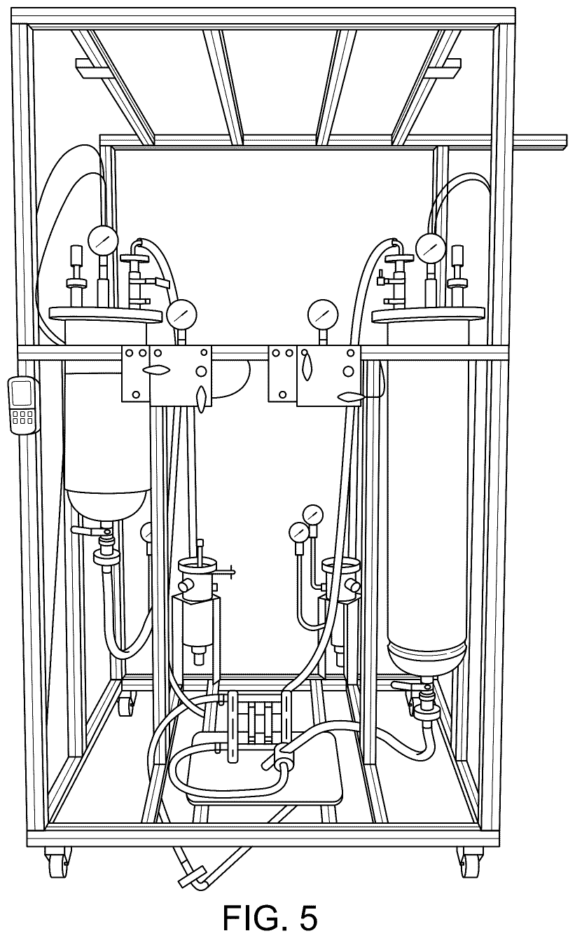

FIG. 5 provides a representation of the thermal processing system components diagrammed above. The image shows a stainless steel evaporator vessel with visible inlet and outlet piping, mounted on a metal frame. Adjacent to it is the spray dryer unit, identifiable by its conical bottom chamber and attached blower system. The calciner appears as a horizontally oriented tubular furnace with ceramic insulation. Thermocouple wires, control panels, and sampling ports are visible throughout the setup. This figure confirms practical implementation of the process steps and highlights real-world considerations such as layout spacing, operator access, and safety equipment integration.

### Exemplary Experiments:

### Operation of the One-Kilogram Feed Capacity REEER System

### Continued Materials Handling of the One-Kilogram System at 500-Gram Scale

Initial materials handling tests using 500 grams of feed were continued across multiple cycles using the same feed. Filtration of the first cycle 1 step 1 cake proved incredibly slow through a filter membrane. Significant amounts of iron hydroxide formed which then completely clogged the filter media to bulk liquids while simultaneously leaking through, preventing any meaningful solid-liquid separation. The purpose of this was to run the system to further observe, diagnose, and optimize the material handling of the system.

### 500 Gram Materials Handling—Cycle 2:

The cake 1 material from the initial 500 grams materials handling test was placed back into reactor 1 with 7 liters of the previous extraction solution. An image of the full reactor is shown in FIG. 5. The solution was measured to have a pH of 10.67. This cycle was heated with air flowing for 2.5 hours, the last hour of which was held above 100° C. The air compressor was largely kept off but was turned on for ten-second intervals four times during the heating process.

Limited yield in the original Cycle 1 experiment encouraged alternate approaches for solid-liquid separation. The first method attempted involved placing all contents after Step 1 in a 5-gallon bucket and letting it settle, followed by removing liquid from the top of the solution. The solution was cloudy and was placed in the filters. The filters were also modified to better facilitate solid-liquid separation. The system previously used custom-made stainless steel filter basket inserts to hold a 90 mm diameter filter paper disc. By the addition of a rubber gasket around the filter sleeve, the housing could be sealed by the inlet pressure to aid in filtration. The material was filtered in this manner and was then placed in the carbonation reactor. Carbon dioxide was added to the reactor at a flow rate of 10 SCFM and pressurized to 10 psi for 30 minutes. The flow was stopped, and the tank was held at 15 psi overnight. The next day, the pH decreased to 9.79. Carbon dioxide was applied for another hour, resulting in a pH drop to 9.70. It was again left under static pressure overnight, after which the pH was 9.59. During subsequent carbonations, the headspace of the reactor was purged by filling the tank to 15 psi, emptied, and refilled three times to displace any ambient air from the reactor. After one more day of bubbling for an hour and static pressure overnight, the pH had only dropped to 9.33. At this point, the total elapsed time since beginning the carbonation step had exceeded three full days without the pH dropping below 8.5. In an attempt to speed up the process over using static pressure, the solution was continuously bubbled for five hours. This decreased the pH to 8.37, indicating that the solution was ready for filtration.

Filtration of Cake 2 was rapid, and the filtrate was clear. Only a few milliliters of solid wet product were produced, likely due to incomplete solid-liquid separation of Cake 1 after the first step. There was likely a large quantity of solution remaining at the bottom of the settling tank. Incomplete solid-liquid separation was further confirmed by the XRF results, which only indicated a 62.5% selectivity for rare-earth elements over base metals. However, from this test, two notable conclusions were drawn: both pressure-sealed filtration and settling were capable of solid-liquid separation, and Step 2 carbonation should take place under continuous bubbling of carbon dioxide.

### 500 Gram Materials Handling—Cycle 3:

A third cycle using the same Cake 1 was processed in Step 1 using the recycled solution from the previous cycle. A starting pH of 10.20 was recorded before Cycle 3 Step 1. The reactor was heated to 110° C. and held at 9 PSI for one hour. The air was left on for five minutes halfway through the hour. After cooling, the liquid was filtered again, this time with no settling tank. Minor modifications to the filter were also performed before this filtration. A supporting steel mesh was used to protect the filter paper and protect ripping under pressure or while removing the cakes. A slightly higher pressure, ranging from 5-15 psi was used to force liquid through the filter.

Before carbonation, the pH was measured at 10.06. A steady flow of carbon dioxide at 5 SCFH and 15 PSIG was applied for one hour, after which the pH had decreased to 9.77. Five hours and twenty minutes under the same flow decreased the pH to 9.37. After static pressure overnight to prevent any increase in pH or temperature-based fluctuations, the solution was at 9.21; another eight hours and twenty minutes decreased the pH to 8.63. Two more hours resulted in a pH of 8.23, at which point the solution was ready for filtration. The carbonation process only required 16 hours and 20 minutes, a significant improvement on the previous cycle. These minor changes resulted in a significant increase in cake volume. The iron to rare-earth ratio of the wet cake, as determined by XRF, was 3.5:1 for Cake 1 and 1:18.8 for Cake 2. This indicates a relatively high selectivity for rare-earth separation from the bulk metal in the magnet.

### 500 Gram Materials Handling—Cycle 4:

The same cake 1 from the previous cycle was processed in the extraction reactor for a fourth time. During step 1, the solution was heated for two hours above 90° C. At that point, compressed air was bubbled through the reactor for 15 minutes, turned off, and the reactor was left for another hour.

Rather than attempting filtration of cycle 4 cake 1, the contents of the reactor were cooled and placed in a settling tank. Two five-gallon buckets were used as successive settling system. The full reactor contents were placed in the first bucket, left overnight, and decanted into the second bucket. The second bucket was again left overnight and decanted into the carbonation reactor. This process produced less product than cycle 4, but significantly more product than cycles 1 and 2. This experiment provides evidence that the solid-liquid separation process can be done without filtration, using only density-based approaches. The iron to rare-earth ratio of the system was 10.6:1 for Cake 1, and 1:11 for Cake 2. The increase in iron percentage in Cake 1 over the previous cycle provides evidence that a repeating scheme of continuous leaching may be used to increase yield of the product.

### 500 Gram Materials Handling—Conclusions

These materials handling experiments provide a wealth of insight into further optimizations. Regarding solid-liquid separation, direct filtration can only be done with a well-sealing filter and a pressure across the medium, as filtration rates are otherwise far too slow to be practical. There is also evidence that density filtration via settling can produce significant amounts of product. During carbonation, a continuous flow of carbon dioxide decreases pH significantly faster than static pressure.

Of particular interest was the qualitative color of poorly-filtering cakes. It was apparent that redder cakes, which may indicate the presence of various forms of iron hydroxide, were difficult to filter. Conversely, the nearly black filter cakes seen on typical laboratory scale experiments filter very quickly. These qualitative observations, along with studies from diagnostic experiments, suggest that the presence of dissolved hydrogen in the solutions encourages the formation of iron hydroxide over more filterable forms of iron oxide.

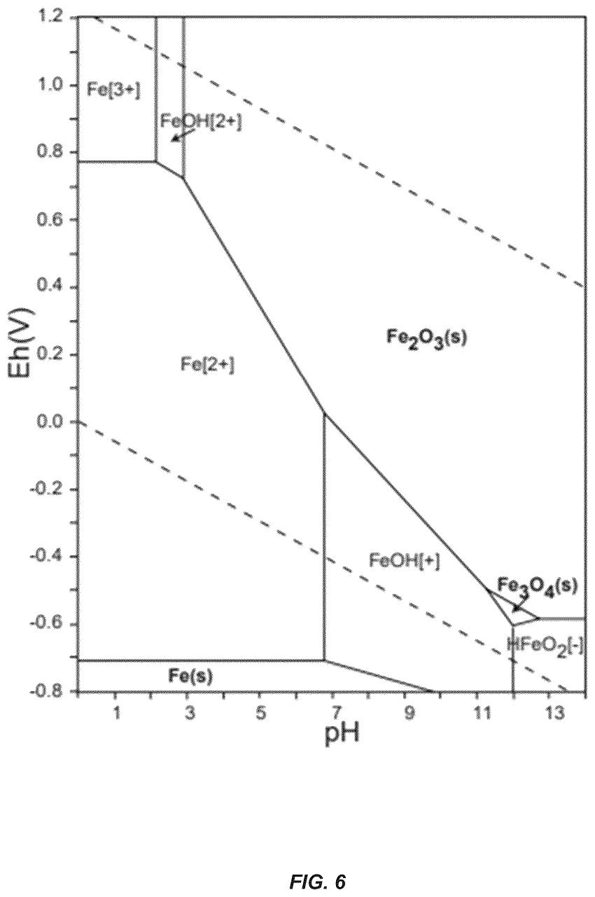

This observation aligns with theoretical thermodynamics of the aqueous iron system. The Pourbaix diagram, shown in FIG. 6, indicates a region where iron hydroxide is the thermodynamically preferred product in the alkaline conditions at the overlap of the hydrogen equilibrium potential.

For example, FIG. 6 presents a Pourbaix diagram for iron in aqueous solution, which plots electrochemical potential (Eh) on the y-axis and pH on the x-axis, in one exemplary embodiment. It identifies stable regions where iron exists as Fe²⁺, Fe³⁺, or solid Fe(OH)₃, and regions where it precipitates or dissolves. This chart provides guidance for selecting leaching conditions, such as pH 5-7 and oxidative Eh, to precipitate iron while maintaining rare earths in solution. The diagram is used to design selective precipitation strategies that reduce impurity co-dissolution during REE recovery.

Iron hydroxide may also act as a sorbent, lowering yield of the rare-earth by trapping it in cake 1. Ultimately, while a settling system proved generally more effective than pressure filtration, the prevention of iron hydroxide formation could result in a much greater overall process yield. Higher temperatures are also expected to promote formation of faster-filtering iron oxide forms.

### Iron Hydroxide Prevention at 500—Gram Scale

A further 500 gram extraction test was performed in an attempt to control the iron hydroxide formation and facilitate more manageable filtration. Based on theoretical studies and prior results, including the diagnostics experiments done on the lab system, it was suggested that higher airflow in the large-scale reactor would prevent the formation of iron hydroxides and instead promote the formation of iron oxides. The reduction of metals in water creates small amounts of hydrogen gas as a byproduct. Higher airflow in the reactor would not only purge the hydrogen, preventing any harmful buildup, but it may also prevent the hydrogen from pushing the reaction towards forms of iron hydroxide.

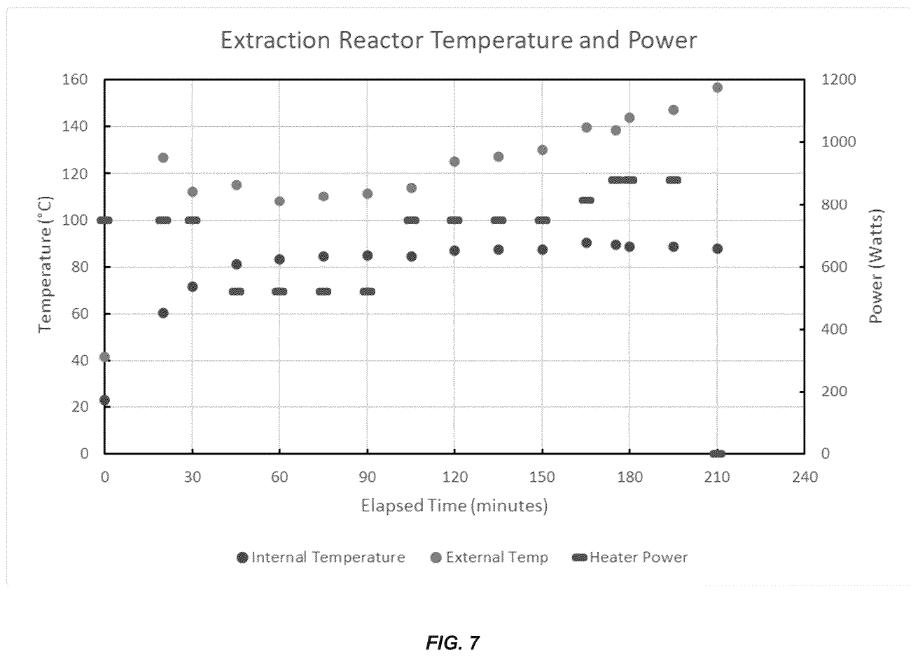

The experiment was conducted by creating a six-molar potassium carbonate-bicarbonate (K_{1.5}H_{0.5}CO₃) solution and adding 500 grams of magnet feed. The solution was heated, and significantly higher airflow was applied. Previous extraction experiments on the one-kilogram-scale system typically had an airflow below 4.5 SLPM, and typically only for a few minutes before the airflow was turned off. This experiment used an airflow of 17 SLPM continuously from 30 minutes after the heat was applied. Due to this large airflow, the heater required more wattage through the variable AC power supply in order to heat the solution. The solution barely reached above 90° C. after two hours of heating. A plot of internal temperature, external temperature, and applied power is shown in FIG. 7 over the course of the experiment.

For example, FIG. 7 presents a graph plotting temperature and power metrics during a high-flow rare earth extraction experiment using a one-kilogram-scale system, in one exemplary embodiment. The x-axis represents elapsed time in minutes; the y-axes (dual) represent internal and external vessel temperature (° C.), and heater power (watts). Three curves are shown: internal temperature (solid line), external temperature (dashed line), and heater power (dotted line). The figure shows how thermal lag affects system heating response and energy demand. The temperature curves demonstrate stable operation once setpoint is reached, confirming system scalability for larger batches.

The solution was passed through a filter bag, and a large quantity of black solid was collected. Iron oxides, which are typically black, generally filter easily. Iron hydroxide compounds, which are often red or brown, can be notoriously difficult to filter. The remaining filtrate still had a small amount of particulates and was left overnight before a second stage of filtration in the modified pressure filter used in earlier experiments. It is likely that iron hydroxides formed inside the filter housing, however, clogging the filter. It is possible that unreacted material generated small amounts of hydrogen, which had the opportunity to push the iron reactant equilibrium toward unfilterable iron hydroxide compounds.

By qualitative observation, the longer the slurry remained in an enclosed system without consistent airflow, the more difficult the slurry was to filter. The results of this experiment imply several opportunities to ensure that the reaction reaches completion to filterable forms of iron oxide before the solution is filtered.

### Engineering and Economic Improvement

### Quadruple-Feed Overloading of the 400 mL System

One proposed method of generally increasing the system capacity without increasing system size is to radically overload the system with feed by a factor of four and reprocessing the Cake 1 multiple times. This would still involve a cyclic process but could enable more flexibility in the feed grade and quality. The three overloading feed experiments consisted of adding 100 grams of magnet feed, rather than the typical 25 grams, to a 200 ml solution. Of these three experiments, the first and third experiments utilized a six-molar potassium carbonate-bicarbonate (K_{1.5}H_{0.5}CO₃) solution. The second utilized a five molar potassium carbonate-bicarbonate solution. The cake obtained from filtering the leaching step was set aside to be used as the feed for the next cycle of leaching after the dilution, carbonation, and boiling steps were completed. The final filtrate was also recycled for the next cycle using KOH to bring the pH back up in preparation for leaching. This process was repeated for 5 cycles of leaching, dilution, carbonation, and boiling. To avoid calcining Cake 1, the cake was not dried in the oven between leaching steps; any drying the occurred was air drying over about 48 hours and did not significantly affect the weight. As the intermediate Cake 1 samples were wet, the yields as determined by XRF are approximate and were only used in relative comparisons. However, the final Cake 1 from each experiment was calcined before an XRF spectrum was obtained to produce reliable value for yield.

Several qualitative observations resulted from this experiment. The time needed to complete the carbonation step decreased over the course of the experiment. The first round of carbonation required around 3 hours of bubbling with carbon dioxide. In contrast, round five only required about 1.5 hours. One other observation was that the mass of Cake 2 after carbonation steps decreased in size significantly by round 5. All Cake 2 samples from the last round had a mass of less than 10 g. This is likely due to the leaching reaction approaching completion as the process continues. Additionally, as the recycling rounds progressed, the color of the Cake 2 products changed from peachy-tan-orange to soft-light-purple-grey. By rounds 4-5 the filtrate was clear in color after carbonation.

In all three cycles, the Fe content in Cake 1 steadily increased until cycle 4 where it begins to stay constant. Conversely, for all three overloaded feed runs, the Cake 2 yield decreased significantly after the first cycle and steadily after that. The selectivity for rare-earth elements over iron remained above 80% throughout, increasing slightly throughout the five cycles to around 95%. These results strongly imply that each new cycle of the extraction step is continually removing more rare-earth elements from the feed, opening the door for more creative system design.

### Incremental Loading

The solution recycling system used by the REEER process suggests that the system may be converted to a semi-continuous process. One proposed schematic of this would be to break up the batch feed into multiple cycles, incrementally loading portions of the batch.

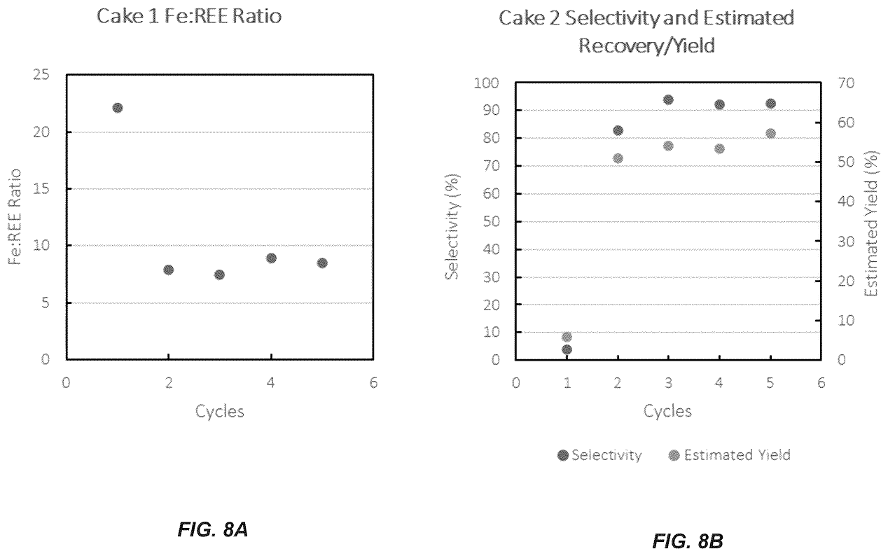

The incremental loading experiments involved adding 25 grams of magnet feed to a 200 mL of six-molar potassium carbonate-bicarbonate (K_{1.5}H_{0.5}CO₃) solution. Leaching was conducted at T˜100° C. and P˜20 psi for three hours; the resulting cake 1 was calcined at 800° C. for five hours. The filtrate obtained during leaching was diluted to 400 mL prior to carbonation; typical carbonation time was ˜3 hours to achieve the desired pH and the resulting cake 2 was calcined at 800° C. for five hours. Prior to each re-leaching step, the filtrate was boiled down to 200 mL and KOH was added to increase the pH back to its initial value; typical masses ranged from ˜6-14 g. The chemical compositions of Cake 1 and Cake 2 for each cycle were analyzed via X-ray fluorescence (XRF), and the data were used to calculate rare earth selectivity, estimated recovery, the ratio of iron to rare earth elements, and the ratio of rare earth elements to potassium. The results are shown in FIGS. 8A and 8B.

In FIGS. 8A and 8B, two performance graphs are presented. The left graph of FIG. 8A plots iron-to-REE ratio in Cake 1 after successive leaching cycles. The x-axis shows the number of cycles; the y-axis shows Fe/REE mass ratio. The downward trend confirms increasing selectivity over time. The right graph of FIG. 8B plots REE recovery yield (%) and iron rejection (%) across trials using an incremental loading feed strategy. It shows high REE yield (>90%) with increasing iron rejection, validating the staged addition approach for efficient separation. Combined, these charts show robustness of the REEER process under repeated use.

This process was conducted for five cycles of leaching, dilution, carbonation, boiling. In FIG. 8A, the iron to rare earth element ratio for Cake 1 is compared across the five cycles. The Fe:REE ratio decreased significantly after the first cycle and remained fairly constant among the subsequent cycles, indicating consistent leaching of rare-earth element during the extraction step in Reactor 1. In FIG. 8B, the estimated selectivity and grade of Cake 2 for the incremental loading experiment is illustrated. Both the yield and selectivity increased significantly after the first cycle; after the third cycle, the selectivity remained fairly constant, while the yield continued to increase slightly.

Solution Recycling without Dilution

In the standard REEER process, the leaching step uses a six-molar potassium carbonate-bicarbonate (K_{1.5}H_{0.5}CO₃) solution which is then diluted with an equivalent quantity of water before carbonation. After the full cycle is complete, excess H₂O is boiled off to return the solution to approximately the same concentration to begin the leaching step again. While boiling off an approximate 200 mL is practical on the small scale, the process of boiling and dilution may present a challenge during further scale-up. One potential method to avoid boiling off large volumes of water is to refrain from dilution completely.

The experiment was conducted twice, once with a six-molar fixed concentration and again with a three-molar fixed concentration of K_{1.5}H_{0.5}CO₃. Note: molar concentrations generally refer to an equimolar mix of potassium carbonate and potassium bicarbonate. Each solution was recycled four times for a total of five cycles. Both experiments used 130 grams of feed, divided into four additions.

The results indicated a significant performance increase in the leaching step as a result of higher potassium carbonate-bicarbonate concentrations. The approximate yield of rare-earth elements as a percentage of metals in Cake 2 of each batch were 44% for the high concentration test and 20% for the low concentration test. For both tests, however, yields were lower than a typical incremental loading test where the solution is diluted before the second step. In a typical experiment, >50% of the starting rare-earth material is recovered in the second cake, with some yields above 80%. Overall, a modified REEER system could be designed without diluting the extraction solution before carbonation. However, the decreased yield may lower economic viability. The process design section described earlier shows that the solution can be regenerated (evaporation and carbon dioxide removal) to produce the desired extraction solution chemistry while employing methods to significantly boost heat recovery.

### Diagnostic Experiments

Due to a wide range of questions that arose during testing, a suite of diagnostic modifications to the rare earth extraction methods were compiled based on observed results to date. Of particular interest were modifications that may improve Step 1 extraction conditions, lead to high rare-earth dissolution extent, and simultaneous precipitation of iron oxide in a form amenable to faster filtration.

The precipitation of iron as iron oxide, specifically Fe₃O₄, rather than the various iron hydroxide compounds could improve filtration after Step 1 and could increase overall rare earth oxide grade and recovery. Poor filtration results in loss of dissolved rare earths to the iron oxide byproduct because of retained liquid and difficulty in washing solution from the cake. Additionally, improved filtration would increase accuracy in determination of the amount of rare earths dissolved during Step 1. The diagnostic experiments also include a preheating step where the solution and the magnet feed are heated to above 70° C. before starting the leaching step.

The two diagnostic experiments were done with air flows of 1 CFH for the first diagnostic test and 6 CFH for the second with the pressure of 20 PSIG and temperature of above 90° C. for both experiments. After leaching for three hours, 1 mL of 30% hydrogen peroxide was added to the solution every 15 minutes. After 45 minutes, 2 mL of hydrogen peroxide was added for the last addition. The pH and ORP we monitored throughout. The leaching step was then filtered and washed twice with 75 mL of distilled water each time. The weight of the cake 1 was recorded, the sample was analyzed by XRF, and then the cake was sealed and set aside for drying.

The solution was diluted from 250 mL to 400 mL in preparation for the carbonation step. Carbon dioxide gas was bubbled through the solution as it was stirred with a flow rate of 10 CFH. Once the pH of the solution was about 9.5 the solution was filtered and washed the same as the leaching step and weight was recorded along with an XRF reading and Cake 2a was set aside for drying. Once the solution reached a pH of about 8.3 the solution was filtered and washed again in the same fashion. The weight and XRF spectra were recorded for Cake 2b before drying. Cake 1, 2a, and 2b were all put through a drying process which consisted of drying the cakes in the oven at 120° C. for 15 minute increments. The cakes considered finished drying when the weight before and after a 15 minute drying interval resulted in little to no effect on the cake weight. A weight and XRF were taken of each cake then the cakes were calcined and another round of XRFs was taken.

One important observation resulted from the diagnostic experiments relating to airflow in the extraction step to filtration of Cake 1. In the first diagnostic experiment, a significantly lower compressed air flow of 1 CFH was used on the leaching step. Cake 1 from the first diagnostic experiment filtered significantly slower than usual. The solution was more of a slurry, and solids were harder to separate. A typical filtration takes less than fifteen minutes; this test with lower airflow required over 1.5 hours. The filtrate was not translucent as usual due to solid particulates getting through filter.

In the second diagnostic experiment, where 6 CFH of airflow was used, the filtration process resulted in nominal solid-liquid separation in under 10 minutes. In a result typical for a successful lab-scale experiment, The cake was black in color, more sold, and could crumble easily.

From these diagnostics, it appears that higher air flow during leaching step improves the filtering on Cake 1. It is likely that low air flow caused more iron hydroxides to form instead of the preferred iron oxides. Iron hydroxides tend to be harder to filter out as they create more of a sludge/slurry which filters slowly and often lets a considerable amount of fine solid material through. There are a few reasons why iron hydroxide compounds may be forming at lower airflow, such as the compressed air could be displacing the hydrogen out of the reactor preventing it from pushing the reaction toward hydroxides, the availability of oxygen in the compressed air could shift the solution potential to prefer the formation of iron oxides, and the compressed air bubbled through the solution could improve mixing and agitation of the solution to push it further to completion.

Other noteworthy observations included low selectivity in Cake 2a & Cake 2b in the first diagnostic experiment, possibly due to filtering halfway and at end of carbonation. Additionally, there was a higher potassium estimate in Cake 2b than Cake 2a, possibly due to higher potassium precipitation at pH closer to 8. In both diagnostic experiments, preheating the magnet feed did not seem to have a significant effect.

Potassium Removal from Product

The presence of potassium salts in the mixed-oxide product presents a possible issue in the commercialization strategy. This contaminant may prevent direct reduction and sintering. A set of experiments was devised to determine if different washing or soaking procedures would remove potassium from the Cake 2 product.

One cycle of leaching, dilution, and carbonation was performed with a six-molar potassium carbonate-bicarbonate (K_{1.5}H_{0.5}CO₃) solution using 25 grams of NdFEB as feed. The Cake 2 rare-earth oxide product from the carbonation step was then used in a series of soaks to determine the best technique for removing potassium from the wet Cake 2 before calcining. A second sample of Cake 2 was used for the carbon dioxide bubbled soak as the previous cake used in the other soaks did not have enough left to provide a full experiment. Each sample was ˜20 g and was left overnight (about ˜17 hours) to soak. The three treatments applied to the cake were: 0.5 molar ammonium carbonate solution, distilled water, and distilled water bubbled with a constant flow of carbon dioxide. XRF spectra were taken at various stages throughout the process to determine how the Cake 2 samples were changing with each step.

TABLE 1
Table 1: The XRF analysis of cakes before and after potassium
removal treatment suggested that all treatments removed
potassium to a varying degree. The potassium to rare-earth
ratio showed an increase in rare-earth each time with the
best being a simple overnight soak in distilled water.

| | K:REE | K:REE | Mass | Mass |
|---|---|---|---|---|
| Treatment Type | Before | After | Before (g) | After (g) |
| None | 1:1 | 1:1 | N/A | N/A |
| Ammonium Carbonate | 1:1 | 1:3.8 | 20.089 | 10.05 |
| Distilled Water Soak | 1:1 | 1:38610 | 20.075 | 10.187 |
| Distilled H₂O with CO₂ | 1:1 | 1:4.7 | 20.011 | 11.136 |
| Bubbled | | | | |
| Seltzer Water Wash | 1:2.3 | 1:4.4 | 10.433 | 8.698 |
| Seltzer Water Soak | 1:2.3 | 1:4.2 | 10.125 | 9.081 |
| Seltzer Water Stir | 1:2.3 | 1:4 | 4.885 | 4.67 |

### Rare-Earth Separation Experiments

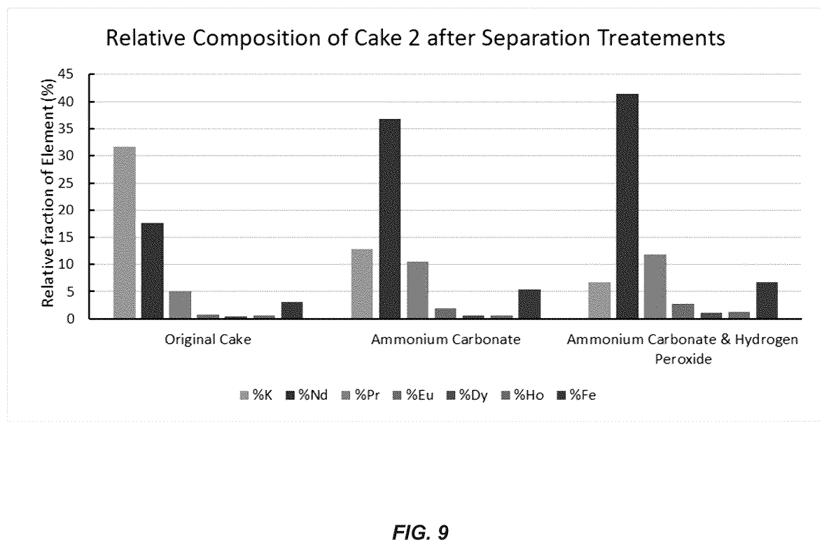

The price of dysprosium per kilogram is typically approximately an order of magnitude more than neodymium. The economics of the REEER process could benefit if a method could be established to enrich or isolate the dysprosium fraction of the Cake 2 product. Ammonium carbonate and hydrogen peroxide were considered as potential reagents to preferentially separate heavier lanthanides (including dysprosium) from the lighter lanthanides. A nominal lab-scale extraction step was performed to produce a Step 1 filtrate. In total, 20 mL of 30% hydrogen peroxide was slowly added to the step one filtrate. First, a couple drops were added, then 1 mL at a time until 5 mL total had been added, then a second 5 mL was added, and finally 10 mL was added to reach 20 mL total. Visual observations were recorded along with temperature and pH. A second set of separation experiments was performed on the step 2 cake. In the first Cake 2 experiment, a sample of Cake 2 was added to a 2 M ammonium carbonate solution. In the second experiment, another sample of Cake 2 was added to a 2 M ammonium carbonate solution mixed with 30% hydrogen peroxide. The elemental percentages of the samples before and after treatment are illustrated in FIG. 9.

FIG. 9 presents a bar graph comparing rare earth element composition across processing stages. The x-axis lists elements (e.g., Nd, Pr, Dy); the y-axis indicates normalized weight percent. Bars for each element represent values in the starting material, post-leachate, and final oxide product. The graph confirms preservation of light REEs (Nd, Pr) while showing effective removal of iron and aluminum. It validates that the process maintains REE integrity and minimizes contaminant carryover.

These results suggest that a large fraction of potassium originally present in Cake 2 was removed, increasing the percentage of rare-earth elements present in the cake. The ratio of neodymium to dysprosium was unchanged in the experiment with both ammonium carbonate and hydrogen peroxide, but increased from a Nd:Dy of 40 to 58 in the ammonium carbonate experiment. This could imply that the dysprosium is more soluble in the solution, but more experiments will be needed to definitively determine if beneficiation of the dysprosium using carbonate solution chemistry is economically practical.

### Solution Regeneration Study

The REEER process includes opportunities for regenerating and reusing the leaching solution for future extraction. Successful implementation of such strategies could benefit the economic model of the project. One of those strategies involves regenerating potassium bicarbonate back into potassium carbonate via heat and pressure or agitation, which could then be reused for step one of the REEER process. Understanding the chemistry behind the regeneration procedure, the three methods that regeneration could be accomplished, and the results of the experiments conducted to ascertain the most viable regeneration method are important for moving forward with the REEER.

During aqueous extraction of rare earths, high pH and oxidizing conditions at temperatures greater than about 80° C. are desired to achieve dissolution of rare earths contained in magnet materials or other sources. These conditions also result in oxidation and dissolution of iron. However, dissolved iron fairly rapidly forms solid-phase iron oxide compounds. The precipitated iron oxide compounds are recovered by filtration as a high-grade byproduct of the REEER process, leaving a clear solution that is rich in dissolved rare earths.

The dissolved rare earth compounds are subsequently crystallized from the extraction solution at ambient temperature by reducing solution pH while providing sufficient carbonate ion concentration to promote formation of solid rare earth carbonate compounds. This is achieved by bubbling carbon dioxide through the aqueous extraction solution according to the following exothermic reaction.

$${K}_{2} {CO}_{3} + {H}_{2} O + {CO}_{2} = 2 {KHCO}_{3} \qquad ΔH = - 98.842 kJ / mole {K}_{2} {CO}_{3} ( 25 ° C . )$$

The crystallized rare earth carbonate compounds formed as pH is lowered are then filtered and recovered as a product. The solution pH is then increased prior to reuse in order to achieve high yields during the next extraction cycle. This is accomplished by converting potassium bicarbonate to potassium carbonate via the reverse of the reaction shown above. Carbon dioxide and water vapor can be removed from the spent solution (after filtration and recovery of the rare earth carbonate product) using a thermal treatment to achieve sufficiently high pH for reuse during the next extraction cycle.

The pH of pure potassium carbonate solution is about 11.7 while the pH of pure potassium bicarbonate solution is about 8.2. A mixture of roughly equal molar proportions of potassium carbonate and bicarbonate is about 10.2, which has been found to be sufficiently high to enable rare earth dissolution. At the conclusion of the rare earth carbonate recovery step, the solution pH is near that of pure potassium bicarbonate. Therefore, the solution is regenerated by employing the reverse of the reaction shown above until a solution pH of greater than about 10 is achieved. A small addition of potassium hydroxide (KOH) can also be made for a final pH adjustment.

Three options for REEER solution regeneration have been identified. These options include the use of a standalone solution regeneration module, in-situ regeneration during the rare earth dissolution step (while operating in the 90° C. range), and a standalone module to regenerate potassium bicarbonate crystals that form as the solubility limit of potassium bicarbonate is reached during carbon dioxide bubbling to reduce pH and form solid-phase rare earth carbonate compounds. Much of the potassium bicarbonate formed in this manner can be filtered prior to any significant formation of solid rare earth carbonate compounds. A hybrid approach to solution regeneration (e.g., using aspects of more than one of the three options) might also be identified based on optimizing reagent recovery (e.g., including carbon dioxide), optimizing heat recovery, and maintaining the process water balance.

A standalone solution regeneration module is an attractive option because process parameters can be controlled independently from those employed during extraction. In addition, options for heat recovery and reuse in the process are facilitated, especially for a continuous regeneration process in which heat from the hot, regenerated solution can be recovered by heat exchange to preheat fresh, ambient temperature feed solution. A potential method for continuous solution regeneration would employ a gas-liquid separation vessel to which pre-heated (e.g., greater than about 90° C.), concentrated potassium bicarbonate solution is fed. Carbon dioxide that is released via thermal treatment can be captured from the separation vessel exhaust for recycle to the rare earth carbonate crystallization step. Water vapor released from the thermal treatment can be condensed and recovered separately or returned directly to the solution using a reflux condenser. A multiple-effect evaporator with three stages was identified as a potential candidate method to achieve simultaneous carbon dioxide and water removal with significant heat recovery to boost efficiency.

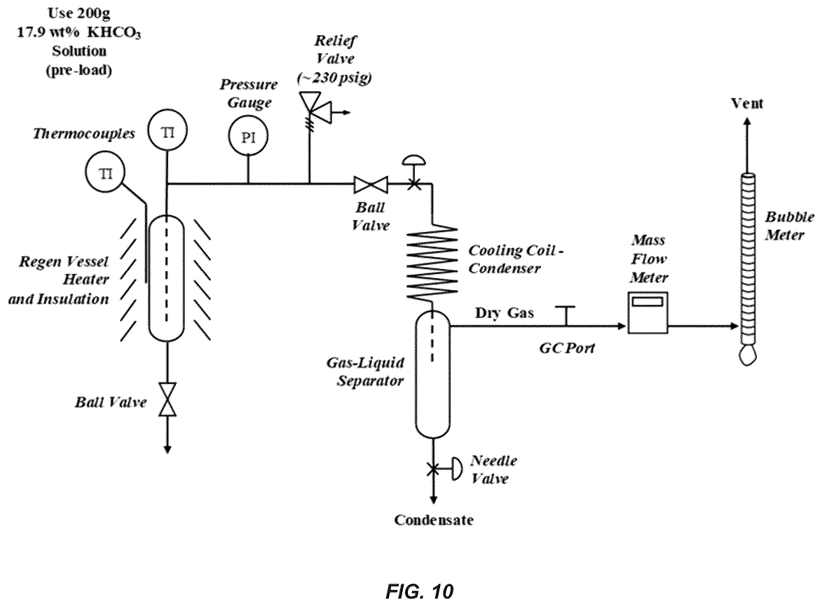

Thermodynamic equilibrium calculations indicated that a potassium bicarbonate solution can be converted to an approximate 50:50 molar mixture of potassium carbonate and bicarbonate by heating to about 150° at a pressure near the saturated water vapor pressure (about 70 psi absolute pressure). The extent of water release can be adjusted by changing the vessel pressure setting. Lower pressure would allow greater release of water vapor relative to carbon dioxide release. The schematic in FIG. 10 illustrates the laboratory apparatus used for testing solution regeneration in a batch mode, along with the lab setup. In general, results obtained near the beginning of batch experiments should provide results that are most-representative of a continuous process in which the feed consists of a composition similar to those used for batch experiments.

In FIG. 10, the initial laboratory batch solution regeneration test configuration is used to evaluate the feasibility of reclaiming and reusing carbonate-based leaching solution. The drawing shows a cylindrical regeneration vessel placed on a magnetic stirring plate with integrated heating. A CO₂ gas inlet connects to the vessel through a flexible hose routed through a pressure regulator and a ball valve for flow control. A mass flow meter is inserted downstream to measure real-time gas delivery rate. The CO₂ gas enters the regeneration vessel at the bottom through a submerged stainless steel tube to allow bubbling through the spent leachate solution. The vessel is equipped with a removable lid housing a pressure gauge and a secondary port for pressure release or sampling. Gas exits through a bubble meter to monitor overall flow and visual bubbling behavior. The configuration enables closed-loop regeneration while controlling gas-liquid contact time, pressure, and carbonate saturation.

Each experiment shows how much CO2 is released in the heating/pressurizing of the vessel. That value can be determined from values shown on the mass flow meter or bubble meter over a range of time. It is also confirmed by the pH value of the solution after the experiment, where the solution would have a pH between 8 and 9 before regeneration and a pH of >10 after. Knowing how much CO2 is released is important to compare to the theoretical value of how much CO2 could be released.

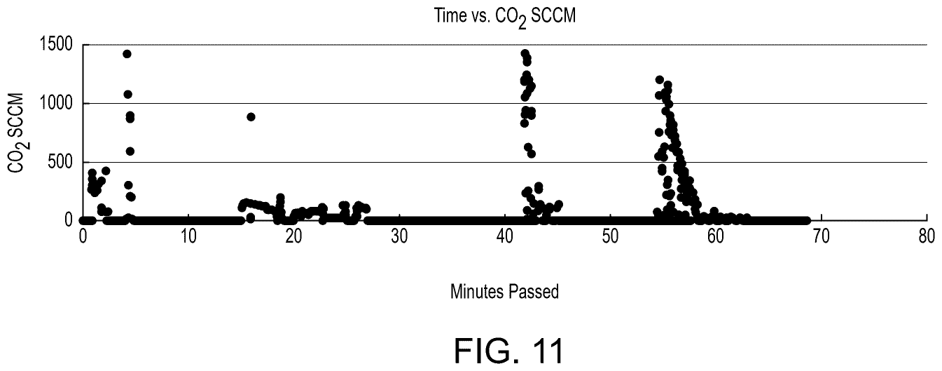

The first setup for the regeneration system involved heating solution inside of a closed off 300 mL Hoke® bottle. As the temperature increased, CO₂ was released and built-up pressure inside the Hoke® bottle. Once different temperatures/pressures were reached, a ball valve would be opened that led to a needle valve. That needle valve is intended to control the flow rate to a mass flow meter as the pressurized CO₂ flowed through the setup. Control of the needle valve can be too imprecise to control the flow accurately, leading to results like the one illustrated in FIG. 11.

In FIG. 11, a line graph showing the CO₂ flow rate over time during an initial solution regeneration experiment is presented, in one exemplary embodiment. The x-axis represents time (minutes), while the y-axis denotes CO₂ flow rate in milliliters per minute. The plot shows an initial ramp-up followed by a stabilization of flow, then tapering off, suggesting gas uptake slows as the solution approaches saturation. This trend helps define the necessary contact duration and flow rate to achieve effective regeneration in future process scale-up.

The sporadic flow rate resulted from the poor control the needle valve provided. Even though this was a poor method of controlling variables, the robustness of the experimental setup was demonstrated in the results of each test. Regardless of most of the combinations of temperature and pressure, as long as the solution was heated for around sixty minutes, the results were usually similar, each with a similar amount of CO₂ released and higher pH value (around 10.2) of the solution post experiment.

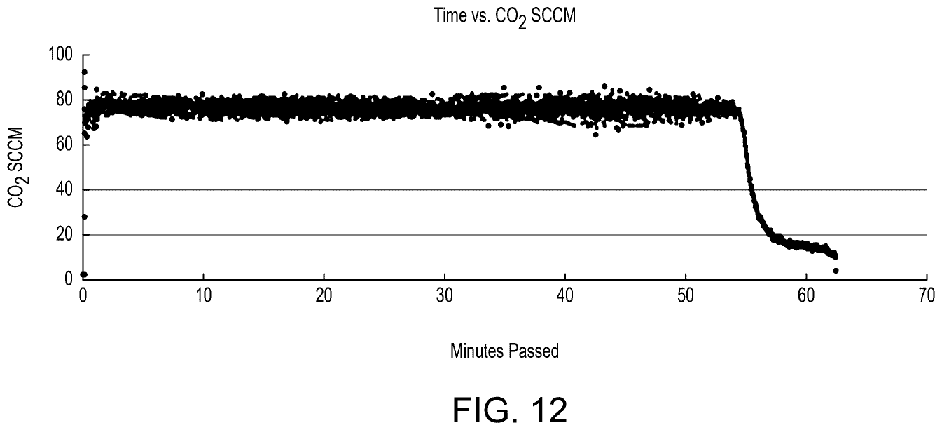

But more control over the flow rate was desired, so the ball valve was abandoned in subsequent experiments, and the mass flow meter was replaced with a mass flow controller. This swap changed the experiment from depending on constant pressure to constant flow rate, which made it easier and more accurate to calculate the amount of CO₂ released by the solution. FIG. 12 illustrates one example of one such experiment where the flow was much steadier.

In FIG. 12, a line graph showing the pH of the leaching solution over time during the same initial solution regeneration experiment is presented, in one exemplary embodiment. The x-axis is time (minutes), and the y-axis is pH. The curve shows an initial rapid drop in pH as CO₂ dissolves and reacts to form carbonate and bicarbonate species, followed by gradual leveling. This behavior indicates the buffering dynamics of the solution and provides insight into regeneration chemistry and endpoint control.

The outcome of this setup produced more consistent results than the previous configuration could provide, where desired pH levels could be achieved, and the amount of CO2 released was more precisely measured. Similar to the first setup, this version also demonstrated a robust nature, where desired results could be easily achieved under most of the conditions examined during these experiments.

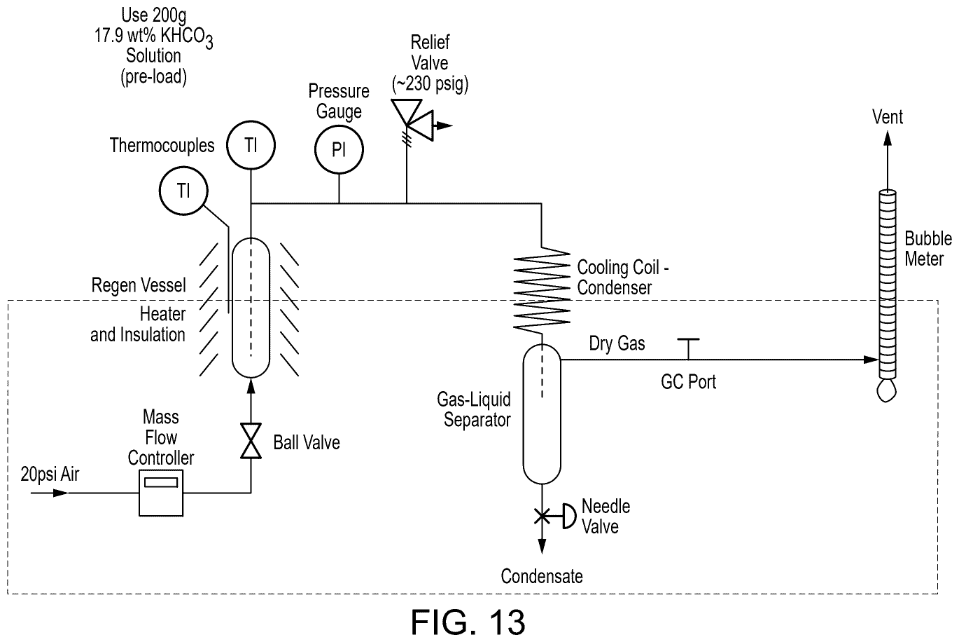

The last version of the experiment attempted to match the characteristics of an in-situ test, where CO₂ would be released in parallel with the extraction step of the REEER process. Basically, instead of a combination of heat and pressure to release CO₂, only heat and agitation through bubbling air would be used. The rare earth extraction procedure (step one) of the scaled-up REEER hardware already has these capabilities, so this setup would provide insight into how well the separate processes would integrate. The diagram depicts the changes made to the original laboratory setup to accomplish this, where only the mass flow controller was moved to the port on the bottom of the vessel as shown in FIG. 13.

In FIG. 13, a laboratory process flow representing the in-situ solution regeneration configuration used to recover carbonate ions in a continuous loop is presented, in one exemplary embodiment. The system begins with a 20 psi compressed air intake, regulated via a manual valve and passed through a flow meter. The air stream is optionally humidified via a bypass humidifier vessel connected through check valves. The main line proceeds into a heated regeneration vessel equipped with a heater band and thermal insulation. Inside the vessel, carbonate-containing filtrate reacts to release CO₂ gas. The vapor stream exits to a gas-liquid separator, then passes through a condenser, followed by a back-pressure regulator and vent system. The flow also includes a needle valve for fine control of pressure, and thermocouples for temperature monitoring. Liquid is recirculated through a feed tank by a gear pump. This setup enables closed-loop carbonate regeneration by driving CO₂ release and reabsorption under thermal control.

300 SCCM air was bubbled into the bottom of the Hoke bottle and a gas chromatograph (GC) sample was taken once the solution inside reached 80-90° C. GC measurements were taken five times; roughly 10 minutes apart during the 65-minute experiment. Bubble meter measurements on the outlet were recorded every 5-10 minutes as well to confirm the dry exhaust gas rate. Any extra CO₂ released by the solution would either be observed in the difference in flow rates between the MFC and bubble meter or in the percent composition that CO₂ made up in the GC results.

A pH increase from 8.8 to 10.0 indicates that integrating the extraction and regeneration processes is feasible. The figures below depict the results of this experiment. Also, a couple off-nominal experiments again showed the robustness of the experiment, where the desired pH was reached simply by heating the solution before putting it in the Hoke bottle.

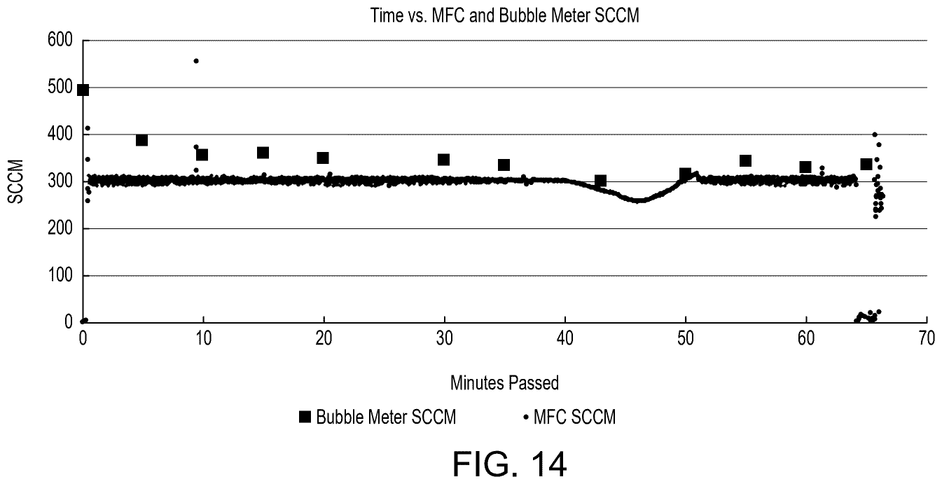

FIG. 14 represents a comparison of inlet and outlet flow. The inlet flow (MFC SCCM) was controlled by DAQ software and set to be around 300 SCCM. The outlet flow (Bubble Meter SCCM) was measured after the air had flowed through the solution, thus capturing the CO₂ released and being a theoretically higher flow than the inlet.

For example, the line graph shows the measured rate of CO₂ release during laboratory in-situ solution regeneration conditions is presented, in one exemplary embodiment. The x-axis denotes elapsed time (minutes), and the y-axis shows CO₂ flow rate (milliliters per minute). The graph shows periodic fluctuations in gas release corresponding to thermal cycling or batch additions of feed solution. This behavior confirms that carbonate decomposition and gas liberation are directly tied to system heat input and mass loading. The experiment validates conditions required to optimize CO₂ removal.

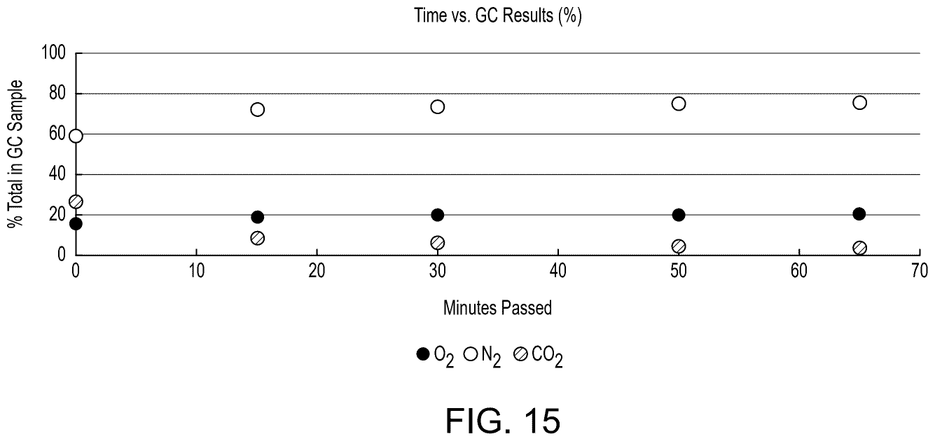

FIG. 15 represents the GC results over the same period the experiment was taking place. CO₂ values dropped over time, clearly mirroring the decrease in difference between the Bubble Meter SCCM and MFC SCCM as time progressed, in one exemplary embodiment. For example, FIG. 15 presents a line graph tracking the gas composition over time during in-situ regeneration. The x-axis shows time (minutes), and the y-axis reports volumetric concentrations of CO₂, O₂, and N₂. The graph illustrates that CO₂ concentration initially rises steeply as carbonate decomposes, then plateaus, while O₂ and N₂ levels remain relatively stable. This profile confirms gas-phase separation efficiency and validates that CO₂ recovery is occurring without contamination from atmospheric gases. The figure supports modeling of gas behavior in scaled-up regeneration systems.

As a result of these experiments and with consideration of industrial scale process controls and heat recovery provisions, a standalone module to regenerate the potassium bicarbonate back into potassium carbonate would be the best option to implement. A continuous regeneration process would provide the best performance and control. Use of a multiple effect evaporator or similar technology would allow for a significant reduction of thermal requirements for solution regeneration. Industrial sizing of a suitable evaporator will be based on the heat exchange surface area needed to achieve the desired CO₂ and H₂O release at the design temperature and pressure at each stage of the evaporation process. These designs are significantly more productive than the laboratory experiment configurations, which can be considered the most-conservative case given the relatively low surface area employed for the batch regeneration experiments.

In summary, several laboratory solution regeneration experiments were successfully conducted using synthetic solutions of potassium bicarbonate followed by a confirmatory experiment using actual REEER spent process solution (filtrate after removal of rare earth carbonate product) over a wide range of temperatures and pressures. Both standalone regeneration and regeneration integrated with rare earth extraction were demonstrated in the laboratory. Regardless of which approach is taken, one result of every experiment remains clear: the regeneration process is robust in nature, and any process that increases the temperature to facilitate the release of CO₂ from the spent solution after rare earth carbonate crystallization significantly increases the pH to allow for reuse during the rare earth extraction step.

### Economic Analysis

An economic analysis for a continuous Rare Earth Element Extraction and Recycling (REEER) plant is based on the process description presented above. Continuous processing (versus batch processing) facilitates heat recovery and system optimization. The plant was sized to accommodate a feed rate of six metric tons per day of magnet material, with magnet manufacturing waste as the baseline case. If the plant operates full-time over the course of a year, it would be able to produce approximately 730 tons of mixed rare earth oxide (REO) product annually, representing 1.4% of the total REEs (estimated as oxides) used in Chinese produced magnets. This size is, therefore, representative of a modest industrial plant and enables capital cost modeling at relevant size. Additional process cases can be applied to other feeds, including end-of-life magnets, to substantially boost the total potential REEER feedstock availability.

The economic analysis represents a boost in fidelity. Greater detail regarding the hardware and energy requirements, along with their associated capital and operating costs, is being introduced into the current economic model. The combined results of laboratory experiments, scaled-up batch extraction and rare earth recovery modules, and modeling as described previously are being used in the process design.

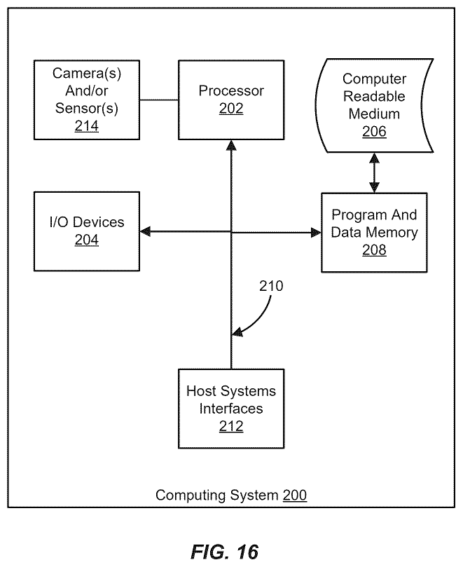

Any of the above embodiments herein may be rearranged and/or combined with other embodiments. Accordingly, the invention is not to be limited to any particular embodiment disclosed herein. Additionally, the invention can also take the form of an entirely hardware embodiment or an embodiment containing both hardware and software elements. FIG. 16 illustrates a computing system 200 in which a computer readable medium 206 may provide instructions for performing any of the methods disclosed herein.

Furthermore, some aspects of the embodiments herein can take the form of a computer program product accessible from the computer readable medium 206 to provide program code for use by or in connection with a computer or any instruction execution system. For the purposes of this description, the computer readable medium 206 can be any apparatus that can tangibly store the program code for use by or in connection with the instruction execution system, apparatus, or device, including the computing system 200.

The computer readable medium 206 can be any tangible electronic, magnetic, optical, electromagnetic, infrared, or semiconductor system (or apparatus or device). Some examples of a computer readable medium 206 include solid state memories, magnetic tapes, removable computer diskettes, random access memories (RAM), read-only memories (ROM), magnetic disks, and optical disks. Some examples of optical disks include read only compact disks (CD-ROM), read/write compact disks (CD-R/W), and digital versatile disks (DVD).

The computing system 200 can include one or more processors 202 coupled directly or indirectly to memory 208 through a system bus 210. Additionally, the computing system 200 may have one or more cameras and/or sensors 214 coupled to the processor(s) 202 to perform in accordance with the embodiments disclosed hereinabove. The memory 208 can include local memory employed during actual execution of the program code, bulk storage, and/or cache memories, which provide temporary storage of at least some of the program code in order to reduce the number of times the code is retrieved from bulk storage during execution.

Input/output (I/O) devices 204 (including but not limited to keyboards, displays, pointing devices, I/O interfaces, etc.) can be coupled to the computing system 200 either directly or through intervening I/O controllers. Network adapters may also be coupled to the computing system 200 to enable the computing system 200 to couple to other data processing systems, such as through host systems interfaces 212, printers, and/or or storage devices through intervening private or public networks. Modems, cable modems, and Ethernet cards are just a examples of network adapter types.

What is claimed is:

1. A system for extracting and recovering rare earth elements (REEs) from magnet-containing feedstock, comprising:
a leaching reactor configured to receive magnet feedstock, an oxidizing gas, and a carbonate-based leaching solution, the leaching reactor being operable to selectively dissolve non-rare-earth constituents and produce a leachate comprising dissolved species and solid rare earth residues;
a solid-liquid separation subsystem coupled to the leaching reactor and configured to separate solid residues from the leachate, producing a clarified leachate stream;
a precipitation subsystem fluidly coupled to the solid-liquid separation subsystem, the precipitation subsystem comprising a sparging device and configured to receive carbon dioxide gas and the clarified leachate stream, and operable to precipitate rare earth carbonate solids;
a filtration and washing subsystem fluidly coupled to the precipitation subsystem, configured to recover and purify the rare earth carbonate solids;
a regeneration subsystem configured to receive spent leaching solution and to react the solution with carbon dioxide to reform the carbonate leaching agent for reuse;
one or more recycle loops fluidly coupling the regeneration subsystem to the leaching reactor for delivering regenerated leach solution back to the leaching reactor; and
a process control system configured to manage the flow of solids, liquids, and gases among the leaching reactor, precipitation subsystem, regeneration subsystem, and recycle loops, such that the system operates in a closed-loop manner with minimal reagent loss and high-purity REE product recovery.
